(19) United States
(12) Patent Application Publication
(10) Pub. No.: US 2010/0290425 A1
(43) Pub. Date: Nov. 18, 2010

(54) OFDM COMMUNICATION CHANNEL

(76) Inventor: Zion HADAD, Rishon Lezion (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/303,403

(22) PCT Filed: Dec. 3, 2004
(86) PCT No.: PCT/IL2004/001103

§ 371 Date: Dec. 4, 2008

(30) Foreign Application Priority Data
Dec. 3, 2003 (IL) 159173

(51) Int. Cl. H04W 72/04; H04B 7/02

(52) U.S. Cl. 370/330; 370/342; 370/335; 375/267; 375/E01.002

(57) ABSTRACT

An OFDM communication channel using both frequency and time diversity (FIG. 1). The OFDM communication channel is used for wireless networks. It further includes a system for performing an ordinary OFDM such as DVB-H/T, and using lower coding rate techniques and interleaving for achieving extra time diversity, frequency diversity, hybrid frequency time diversity or further frequency, time and space diversity.

### TECHNICAL FIELD

The present application claims priority from application No. 159173 filed in Israel on 3 Dec. 2003.

The present invention relates to improvements in OFDM communication channels, using frequency and time diversity systems and methods.

### BACKGROUND OF THE INVENTION

The invention relates to networks using multi-carrier or Orthogonal Frequency Division Multiple OFDM or OFDM Access (OFDMA).

A problem in such prior art channels is to compensate for gaps in the frequency coverage, frequency selective fades or interference or other channel impairments, which may obscure part of the allocated frequency spectrum. In a wideband system, a significant part thereof may be blocked at any given time.

Moreover, the blocked frequency region may move across the frequency spectrum, as the mobile user moves to another location or due to other factors influencing the channel, such as cars moving around the receive Antenna.

A simple method is required, to whiten the channel and improve communications, using a simple implementation, so as to keep the cost low and to reduce power consumption in the mobile unit.

It is an objective of the present invention to overcome the above and other various problems in OFDM wireless networks. Special treatment, by way of example, is given to the 802.16a/d/e OFDM 256 and OFDMA 2k modes.

The extension to a reuse factor of 1 is discussed, while implementing the new FEC/diversity method as an addition to the standard.

### SUMMARY OF THE INVENTION

According to the present invention, there is provided a system and method for wireless OFDMA.

The invention may be used with the standard 802.16 or 802.11a, 802.11b or any ordinary OFDM such as DVB-H/T, and using lower coding rate techniques and interleaving for achieving extra time diversity, frequency diversity, hybrid frequency time diversity or further frequency, time and space diversity.

By using the above methods, a reuse technique is implemented by repeat transmission with diversity, by 2 repeats, 4 repeats and N repeats of each of the possible error correction codes or by simply using lower rates FEC which can go down to 1/N where N can be a large value.

The current OFDM used by 802.16, 802.11, as well as other proposed standards, did not consider the frequency reuse factor of the system when it is covering a area by several cells or sectors. The advantage of reuse 1 has been explored in CDMA systems such as IS-95, where it gives some advantages in cells planning and system scalability, by adding more cells or creating cell splitting.

The present invention enhances the above solution, adapts it and applies it to current, existing OFDM/A standards.

OFDM time diversity can be achieved by introducing packet data protected by FEC at different rates and spreading the transmit code word spread in time by breaking the code word to several sub-groups of symbols (starting from 1) and transmitting them separate in time.

The separation time is chosen in such a way so that the correlation between the two transmissions, as far as the channel behavior is concerned, is minimal, of course under the constraint of the delay allowed for the data.

In OFDM, this time diversity means transmission separation time of several OFDM symbols. The FEC can be any well known method such as BCH, Convolutional, RS, TPC, CTC, LDPC, and repetition.

Since in mobile we might have users which are fixed or moving slowly, the channel may change slowly and this might imply long delays in the transmission, since we will need a long time separation of the sub-code word.

In order to resolve this problem, we will take the advantage of frequency diversity where, unlike CDMA, we can transmit the symbols of the code word in different sub-carriers, which are spread in the Broadband/Wideband allocated spectrum in a frequency distance greater the coherent BW.

The channel correlation between these two symbols is minimum. Of course, if the channel is not wide, then we might get lower frequency diversity. In case of a low delay and low BW system, in a preferred embodiment one will chose the hybrid approach of time and frequency diversity.

For example, for the 256 OFDM of 802.16 which is currently designed for a reuse factor less than 1 (neighbor sectors and cells are using different frequencies), we can combined both diversity and reuse 1 using the following system structure and Method:

1. Let us take all the allocated frequencies and use them in one channel for one base/sector. For example, in the case of 256 OFDM, we can achieve x4 times the frequency spread.
2. We next will introduce lower FEC rates: We achieve a factor of x4 in the BW (bandwidth), therefore we can decrease the rates by factor of 4 and we can get a better reception of our signal by using the idea of hybrid frequency and time diversity.

In a simple embodiment of the above detailed invention and basic approach, one can use the existing FEC method and just repeat the transmitted code words (currently 192 per OFDM symbols) in different OFDM symbols and different interleaves in each OFDM symbols.

Interleaving can be performed using pre-defined (pre-existing) tables, or by using RS sequences formula for symbols allocations in an OFDM symbols or by simply rotating cyclically the allocations, for example 192/2 right for the second OFDM symbol and then extra rotation of 192/4 and then 192/2 to the left and then 192/4 to the right and so on, depending on the number of repetitions.

3. Define the maximum # N of repetitions needed (or the lowest code rates):
this number is derived for an agreed channel propagation in the coverage area: rural, sub urban or urban; The minimum data rates which we want to support, the cells' size, the coverage outage probability and the speed of the subscriber.

For example, by running a simulation on the ITU model for mobiles, we found that in the down-link we need to support less than −5 dB SNR for a coverage probability of 99%. In omni-antenna BS (base station) cell and in sectored cells (3 or 6 or . . . ) this number becomes lower. By using this numbers we simulated the channel in different speeds (Doppler shift) and we found that code rates that can go down to 1/12 might be a good conformist (in case of CTC—convolutional Turbo code rate 1/2 and 6 repetitions).

Of course, this code rates are chosen adaptively, according to a user's requirements (SNR etc.) where users nearer to the BS may work in 64 QAM rate 5/6 with no repetition and users which are closer to the outer perimeter of the cell may be allocated QPSK rate 1/2 with the needed repetitions.

If the system will, in addition, use the transmit/received antenna diversity schemes or other this #N number will changed accordingly.

The adaptive coding, modulation, space antenna diversity etc. are done automatically by the MAC using functions like scheduler and QOS.

In our invention, we have to add the lower coding rates, codes to the current system which will introduce the reuse 1 and, accordingly, will improve the system by broader frequency diversity, enhanced immunity to interferences, better overall capacity, better scalability for introducing more cells/sectors in a coverage area when it is needed, bigger cells, etc.

4. preamble usage: In the current OFDM 256 draft, the preamble is built by using a First OFDM symbol that transmits pilots every fourth sub-carrier, while the others are empty, and the second OFDM symbol which are transmitted pilots on every second sub carrier.

The randomization of the preamble pilots is the same for all the sectors/cells and this, in a big deployment, will confuse the users and the capabilities of the receivers to synchronize properly.

It is recognized that at own BS, at the edge of the cell, may be impossible.

In order to solve that problem, we need a different randomization sequence per cell/sector and in case of STC (space time code), which uses several antennas, we need a different sequence per transmit antenna in order to estimate each channel from an antenna BS to an antenna user which each one may have several antennas. The preamble randomization sequences should be chosen by looking for low PAPR in the time domain. Low PAPR would allow to boost the preamble power without problems from the power amplifier, compared to the data OFDM symbols which are random.

This improvement in the preambles may be applicable for the uplink as well. The randomization sequence should have low cross correlation in the frequency domain. The randomization can be real amplitude +−1 or complex like exp(teta) where the phase teta is pseudo random for example +−1 or +−i.

The second improvement is to use the preambles in neighbor cells in a different allocation in the frequency domain, where one sector will transmit the pilots preamble, for example, on sub channels 1, 5, 9, . . . and the second sector will transmit on 2, 6, 10, . . . the third sector will transmit

It is very important that the randomization sequence will be with low cross correlation in order to achieve good frequency estimation. By doing this frequency separation we achieve lower or minimum interference.

On the pilots and accordingly, it is possible to achieve a very good estimation of the SNR relative to other BS/ sectors very clean and coherent channel estimation and data detection synchronization, etc.

In OFDMA systems (for example, as described in IEEE 802.16a or in EN-301-958), the channel is separated into sub-channels, for example the channels C1, C2, C3, C4 as illustrated in FIG. 3, wherein each sub-channel is spread over the entire bandwidth and interleaved with the other sub channels. This scheme achieves improved frequency diversity and channel usage (no need for frequency separation between sub-channels).

The above frequency reuse 1 is applicable for OFDMA or any other method using a plurality of sub-sets of sub-carrier out the set of the sub-carriers that are defined by the FFT size. For example, this subset (we called it sub-channel) may spread on the entire frequency band or can be grouped to one block or can divided to several blocks of subgroups which may spread on the entire spectrum (each block in a different location).

For example, in a system according to IEEE 802.16 for mobile applications the basic synchronization sequence is based on a predefined sequence of data that modulates a subset of the sub-carriers. Sub-carriers belonging in this subset are called pilots and are divided in two groups.

One group is of fixed location pilots and the other is of variable location pilots. There is a variable location pilot every twelve sub-carriers, and it is changing position each OFDMA symbol with a cycle repeating every four OFDMA symbols.

The present invention may be combined with another invention, which has been disclosed in a prior patent application by the present inventor.

Accordingly, this refers to the possible use of CDMA over OFDMA. In the present invention, however, an improved method is disclosed, Wherein the dispersion in frequency is implemented using Reed-Solomon codes. This achieves a whitening of the CDMA chip collisions with other cells, to minimize the effects of such collisions.

Further objects, advantages and other features of the present invention will become obvious to those skilled in the art upon reading the disclosure set forth hereinafter.

### BRIEF DESCRIPTION OF THE DRAWINGS

FIG. 1 The structure of OFDM symbols including data and pilots

FIG. 2 details a channel having an irregular frequency and data channels rotation among themselves

FIG. 3 details data channel mapping so as to reduce channel irregularities, using for example R-S codes

FIG. 4 illustrates possible improvements in the SNR required for a specific PER, using the above system and method.

FIG. 5 details a WLAN system with is overlap with adjacent WLAN cells with reuse factor different than 1.

FIG. 6 details carriers allocation by a basic series and its cyclic permutations.

### DETAILED DESCRIPTION OF THE INVENTION

A preferred embodiment of the present invention will now be described by way of example and with reference to the accompanying drawings.

The invention may be used with the standard 802.16e or 802.11a, 802.11b or any ordinary OFDM such as DVB-H/T and using reuse techniques. A reuse technique may be implemented by repeat transmission with frequency diversity, by 2 repeats, 4 repeats and N repeats of each of the possible error correction codes.

For example, using an ordinary OFDM with a 192 size block, the blocks may be transmitted either at adjacent time intervals or with a time separation there between.

The latter method is preferable, to also achieve a diversity in time.

At 2.4 GHz there are only 4 frequencies of 20 MHz for a reuse of 1/4. Since this band is unlicensed, each system is independent of the others and may interfere with the others, despite a possible use of CSMA/CD algorithms now in use in 802.11a (not existent in ETSI HYPERLAN-2).

The present invention may be combined with another invention, which has been disclosed in a prior patent application by the present inventor. Accordingly, this refers to the possible use of CDMA over OFDMA. We took each symbol and performed randomizing there on N times (chips) with a pseudo-random +−1 like spreading in CDMA.

The resulting chips have been spread over the existing sub-channels.

In the receiver, the chips have been collected and combined coherently to build back the original symbol.

Prior art articles detail chips dispersion, wherein chips are chosen using Walsh codes, which are orthogonal over 8 sub carriers. It is possible to disperse 8 symbols in frequency etc.

In the present invention, however, an improved method is disclosed, wherein the dispersion in frequency is implemented using Reed-Solomon codes. This achieves a whitening of the collisions between the chips of other cells, to minimize the effects of such collisions.

For example, if a user transponder allocates its chips in the frequency domain using a RS (Reed-Solomon) sequence of length M and another user will use a RS different sequence from the same family, then the allocations will collide in one place out the M. This is a very small amount of interference indeed, compared to collision on all the sub-carriers.

Now, if one wants another degree of improvement, he can erase this symbol before the MRC combining in order to extra minimize the effect of this sub-carrier collision.

The same approach of spreading can be performed by using other pseudo-random allocation (not RS) which may have other number of collision (may be different than 1), depending on the cross-correlation between the sequences.

Still, within the cell and between different users, we can keep no collision of sub-carriers (as mentioned in a previous patent application by the present Inventor).

Thus, by using the above spreading method, more networks, each independent of the others, can coexist over a common frequency band.

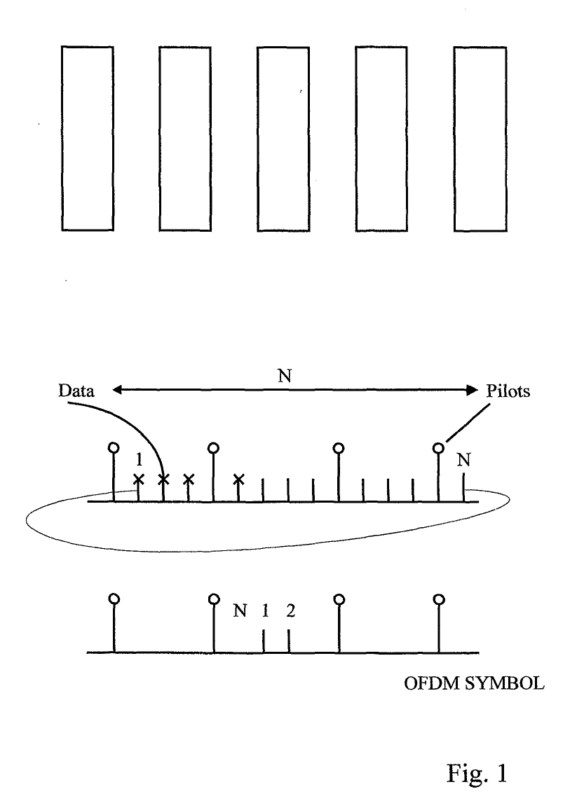

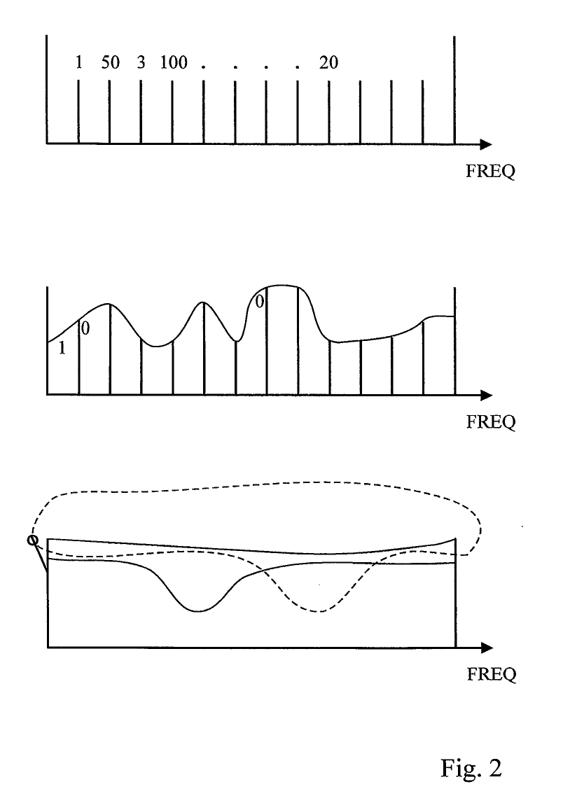

The OFDM symbols that include data and pilots are illustrated in FIG. 1. To improve the performance in a typical communication channel, which usually has a an irregular frequency response as illustrated in FIG. 2, the data channels may be rotated among themselves.

Thus, a data channel may encounter, at some interval in time, higher transfer losses and a higher error rate. The same data channel, transmitting the same data in a diversity transmission, may encounter, at another interval in time, lower transfer losses and lower error rate.

Using a maximum ratio combiner and diversity techniques, the overall performance is significantly improved in that channel. Similar improvements are achieved in the other channels.

Various error correction code embodiments of the invention are possible for example at FEC rates of 1/2, 1/3, 2/3 or 3/4, corresponding to a rate of XD to XP of 1/2 to 1/2, 2/3 to 1/3, 3/4 to 1/4, etc.

Using a maximum combiner of two repetition of 3/4 becomes 9/16, etc.

The present system and method may also implement a channel estimator using the pilots in the channel.

Various methods may be used for implementing the data channel rotation, for example:

a. Cyclic rotation
b. Mapping using Reed-Solomon codes, over the whole OFDM symbol or other pseudo-random methods are possible (N subchannels).

The original data channel is then combined with the rotated data channel. This achieves a channel's whitening, practically compensating for irregularities in the channel.

Any gaps in the channel are dispersed among the data and thus compensated for.

A simple implementation of the above can be implemented, to achieve a low cost, low power consumption system.

The result is improved diversity performance, using frequency diversity in combination with (optional) time diversity.

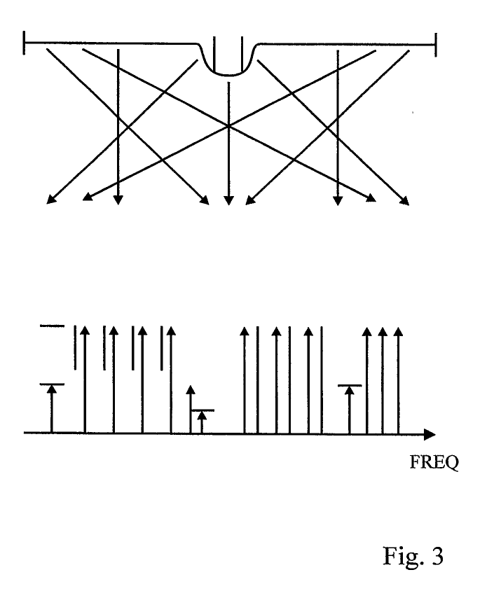

FIG. 3 details data channel mapping so as to reduce channel irregularities, using for example R-S codes.

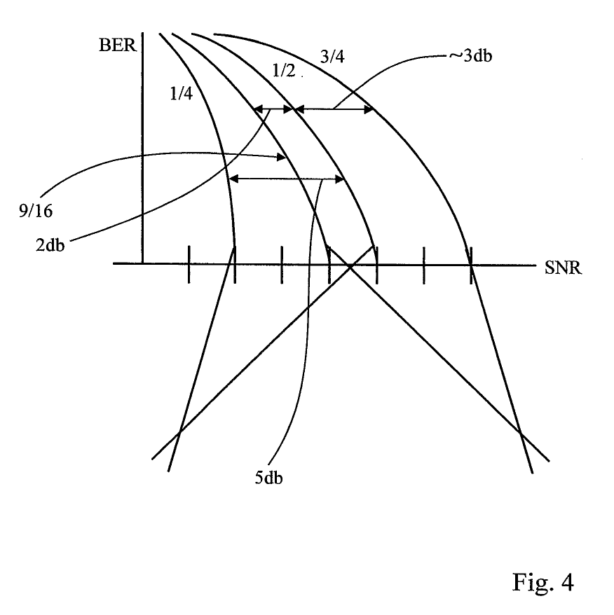

FIG. 4 illustrates possible improvements in the SNR required for a specific PER, using the above system and method.

### PER—Packet Error Rate.

Improvements of about 5 dB may be achieved, a significant improvement.

An additional 3 dB or more may be achieved using time diversity.

### Diversity Method

1. The method includes, in OFDMA, transmitting the same subchannels twice or N times, over different subcarriers, This achieves frequency diversity.
2. If we choose the subchannels in a different OFDMA symbol, then we achieve both time and frequency diversity. Thus, improved channel whitening is achieved, to compensate for changes in time and/or changes in frequency in the channel.
3. In prior art regular OFDM, such as WLAN 802 11a, only time diversity can be implemented. The present invention may be implemented as an improvement in this standard, for improved diversity performance.

### End of Method.

When performing a N-times diversity, large improvements may be achieved, and the system may operate at negative SNR values. For example, in a white channel, a 10 Log(N) (in dB) improvement may be achieved.

Large improvements may also be achieved in channels with multipath as detailed above.

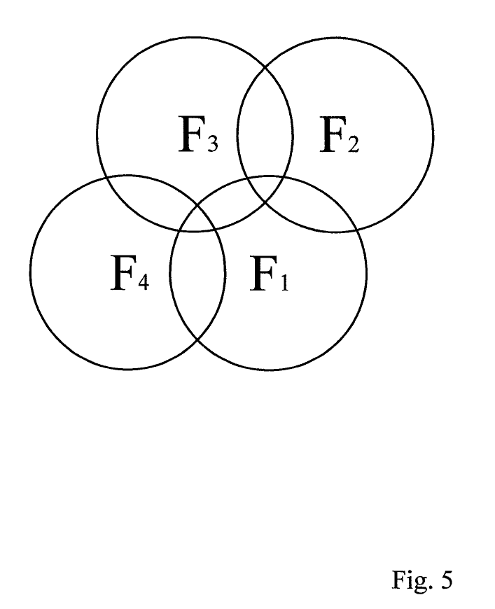

The diversity improvement as disclosed in the present invention is also applicable in WLAN systems where there is overlap with adjacent WLAN cells, to achieve a WLAN system with reuse 1, see FIG. 5.

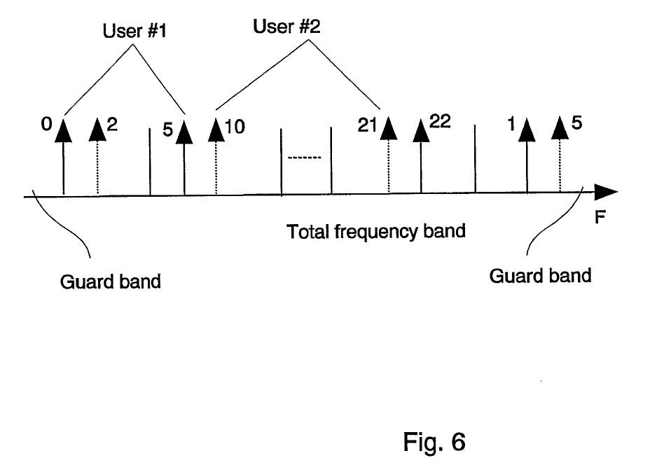

FIG. 6 details carriers allocation by a basic series and its cyclic permutations.

Carriers are allocated by a basic series and it's cyclic permutations for example:

### Basic Series:

0,5,2,10,4,20,8,17,16,11,9, 22, 18,21,13,19,3,15,6,7,12,14,1

After two cyclic permutations we get:

2,10,4,20,8,17,16,11,9,22,18, 21, 13,19,3,15,6,7,12,14,1,0,5

Thus, for example, User 1 will be allocated the series:

0,5,2,10,4,20,8,17,16,11,9, 22, 18,21,13,19,3,15,6,7,12,14,1
and User 2 will be allocated the series:
2,10,4,20,8,17,16,11,9,22,18, 21, 13,19,3,15,6,7,12,14,1,0,5

Further guard intervals are allocated on both sides of the spectrum, as illustrated for the above example.

It will be recognized that the foregoing is but one example of an apparatus and method within the scope of the present invention and that various modifications will occur to those skilled in the art upon reading the disclosure set forth hereinbefore.

What is claimed is:

1. In a wireless OFDM or OFDMA system, means for compensating for channel impairments comprising time diversity means implemented by introducing packet data protected by FEC at different rates and spreading the transmit code word spread in time by breaking the code word to several sub-groups of symbols (starting from 1) and transmitting them separate in time.

2. The compensating means according to claim 1, wherein the separation time is chosen in such a way so that the correlation between the two transmissions, as far as the channel behavior is concerned, is minimal, and under the constraint of the delay allowed for the data.

3. The compensating means according to claim 1, wherein in OFDM, the time diversity comprises transmission separation time of several OFDM symbols.

4. The compensating means according to claim 1, wherein the FEC comprises BCH, Convolutional, RS, TPC, CTC, LDPC, and/or repetition.

5. The compensating means according to claim 1, wherein the channel impairments include gaps in the frequency coverage, frequency selective fades and/or interference.

6. The compensating means according to claim 1, wherein the system complies with the standard 802.16 or 802.11a, 802.11b or DVB-H/T.

7. The compensating means according to claim 1, wherein the system further uses lower coding rate techniques and interleaving for achieving extra time diversity, frequency diversity, hybrid frequency time diversity or further frequency, time and space diversity.

8. The compensating means according to claim 1, further using
a reuse technique by repeat transmission with diversity, by 2 repeats, 4 repeats and N repeats of each of the possible error correction codes or by simply using lower rates FEC which can go down to 1/N where N can be a large value.

9. In a wireless OFDM or OFDMA system, means for compensating for channel impairments comprising frequency diversity means implemented by transmitting the symbols of the code word in different sub-carriers, which are spread in the Broadband/Wideband allocated spectrum in a frequency distance greater the coherent BW.

10. The compensating means according to claim 9 being applied to 256 OFDM of 802.16 which is designed for a reuse factor less than 1, and using a combined diversity and reuse 1.

11. The compensating means according to claim 10, wherein the combined diversity and reuse 1 comprises:
A. Means for taking all the allocated frequencies and using them in one channel for one base/sector;
B. means for performing lower FEC rates, to achieve a factor of x4 in the BW (bandwidth), to decrease the rates by factor of 4 and to get a better reception of our signal by using hybrid frequency and time diversity;
C. means for implementing a maximum # N of repetitions needed, wherein N is derived for an agreed channel propagation in the coverage
area: rural, sub urban or urban; The minimum data rates which we want to support, the cells' size, the coverage outage probability and the speed of the subscriber;
D. means for implementing a randomization of the preamble pilots.

12. The compensating means according to claim 11, wherein using the existing FEC method and just repeat the transmitted code words (currently 192 per OFDM symbols) in different OFDM symbols and different interleaves in each OFDM symbols.

13. The compensating means according to claim 11, wherein interleaving is performed using pre-defined (pre-existing) tables or by using RS sequences formula for symbols allocations in an OFDM symbols or by simply rotating cyclically the allocations.

14. The compensating means according to claim 13, wherein rotating cyclically the allocations is implemented by a 192/2 right rotation for the second OFDM symbol and then extra rotation of 192/4 and then 192/2 to the left and then 192/4 to the right and so on, depending on the number of repetitions.

15. The compensating means according to claim 11,
wherein N in omni-antenna BS (base station) cell and in sectored cells (3 or 6 or . . . ) becomes lower.

16. The compensating means according to claim 11, wherein
the system additionally uses transmit/received antenna diversity schemes and the #N number is changed accordingly.

17. The compensating means according to claim 11, further including means for performing the adaptive coding, modulation, space antenna diversity, etc. automatically by the MAC using functions like scheduler and QOS.

18. In a wireless OFDM or OFDMA system, means for the
randomization of the preamble pilots using means for performing a randomization sequence per cell/sector and in case of STC which uses several antennas, using a different sequence per transmit antenna in order to estimate each channel from an antenna BS to an antenna user which each one may have several antennas, and the preamble randomization sequences is chosen by looking for low PAPR in the time domain.

19. The means for randomization of the preamble pilots according to claim 18, further including randomization means for the uplink using a randomization sequence having a low cross correlation in the frequency domain.

20. The means for randomization of the preamble pilots according to claim 18, wherein preambles in neighbor cells or sectors use a different allocation in the frequency domain.

21. In a wireless OFDMA system, a method for compensating for channel impairments comprising:
A. Transmitting the same subchannels twice or N times, over different subcarriers, to achieve frequency diversity.
B. if the subchannels are in a different OFDMA symbol, then both time and frequency diversity are achieved.

22. The compensating method according to claim 21 being applied to a regular OFDM, such as WLAN 802 11a, and wherein only time diversity is implemented.

23. The compensating method according to claim 21, wherein carriers are allocated by a basic series and it's cyclic permutations.

24. The compensating method according to claim 21, wherein
a user transponder allocates its chips in the frequency domain using a RS (Reed-Solomon) sequence of length M and other users will use a RS different sequence from the same family.
